(19) United States
(12) Patent Application Publication
(10) Pub. No.: US 2020/0126686 A1
(43) Pub. Date: Apr. 23, 2020

(54) POWER CABLE WITH NON-CONDUCTIVE ARMOR

(71) Applicant: Saudi Arabian Oil Company, Dhahran (SA)

(72) Inventors: Basel Ishwait, Dhahran (SA); Abdullah Al-Muways, Dhahran (SA)

(73) Assignee: Saudi Arabian Oil Company, Dhahran (SA)

(21) Appl. No.: 16/163,716

(22) Filed: Oct. 18, 2018

(51) Int. Cl. H01B 7/28; H01B 1/04; H01B 13/22

(52) U.S. Cl. CPC H01B 7/28; H01B 13/22; H01B 1/04

(57) ABSTRACT

Systems and methods for providing power to a device in a hydrocarbon development operation include a cable having a single core conductor. The single core conductor is an elongated member with a central axis and is operable to conduct electricity. An insulation member circumscribes the single core conductor and extends the length of the single core conductor. The insulation member has an annular cross section centered around the central axis of the single core conductor. An armor layer circumscribes the single core conductor and extends the length of the single core conductor. The armor layer has an annular cross section centered around the central axis of the single core conductor and is formed of a non-conductive material incapable of conducting a current. The armor layer is radially exterior of the insulation member.

### BACKGROUND OF THE DISCLOSURE

### 1. Field of the Disclosure

The disclosure relates generally to power cables, and more particularly to single core power cables with a non-conductive armor.

### 2. Description of the Related Art

Armored power cables are used for providing power to certain devices, such as tools and equipment used in the hydrocarbon development industry. The armor layer can provide physical protection to improve system reliability and reduce damage to the power cable. Some currently available armored power cables have an armor layer formed of steel or aluminum.

### SUMMARY OF THE DISCLOSURE

Some single core power cables experience high circulating current, which allow the current to pass through the armor layer. The current in the armor layer can be a circulating current, an eddy current, or a system fault. The current in the armor layer could be detrimental to the power cable. As an example, currents within the armor layer can produce power losses, such as by heating, and decrease the capacity of carrying current of the power cable. The current in the armor layer can alternately generate a magnetic field that alters the overall magnetic field of the power cable.

Embodiments disclosed herein describe systems and methods for providing an armor layer that provides physical protection to the single core power cable that is non-conductive so that the armor layer is incapable of conducting a current.

In an embodiment of this disclosure, a cable for providing power to a device in a hydrocarbon development operation has a single core conductor, the single core conductor being an elongated member with a central axis and operable to conduct electricity. An insulation member circumscribing the single core conductor and extending the length of the single core conductor, the insulation member having an annular cross section centered around the central axis of the single core conductor. An armor layer circumscribes the single core conductor and extends the length of the single core conductor. The armor layer has an annular cross section centered around the central axis of the single core conductor. The armor layer is formed of a non-conductive material incapable of conducting a current. The armor layer is radially exterior of the insulation member.

In alternate embodiments, the cable can further include a sheathing circumscribing the armor layer. At least one layer of water blocking tape can circumscribe the single core conductor and extend the length of the single core conductor. The at least one layer of water blocking tape can have an annular cross section centered around the central axis of the single core conductor. The cable can further have a supply end and a load end, where the supply end and the load end are operable to be connected to equipment through a ferrous plate. The supply end can be operable to be connected to a supply and the load end can be operable to be connected to the device. The armor layer can be free of a voltage over an axial length of the armor layer.

In another embodiment of this disclosure, a system for providing power to a device in a hydrocarbon development operation includes a power cable extending from a power supply to the device. The power cable has a single core conductor. The single core conductor is an elongated member with a central axis and is operable to conduct electricity. An insulation member circumscribes the single core conductor and extends the length of the single core conductor. The insulation member has an annular cross section centered around the central axis of the single core conductor. An armor layer circumscribes the single core conductor and extends the length of the single core conductor. The armor layer has an annular cross section centered around the central axis of the single core conductor and is formed of a non-conductive material incapable of conducting a current. The armor layer is radially exterior of the insulation member. The armor layer is free of a voltage over an axial length of the armor layer.

In alternate embodiments, a sheathing can circumscribe the armor layer. The cable can further include at least one layer of water blocking tape circumscribing the single core conductor and extending the length of the single core conductor. The at least one layer of water blocking tape can have an annular cross section centered around the central axis of the single core conductor.

In another alternate embodiment of this disclosure, a method for providing power to a device in a hydrocarbon development operation includes extending a power cable from a power supply to the device. The power cable has a single core conductor, the single core conductor being an elongated member with a central axis and operable to conduct electricity. An insulation member circumscribes the single core conductor and extends the length of the single core conductor. The insulation member has an annular cross section centered around the central axis of the single core conductor. An armor layer circumscribes the single core conductor and extends the length of the single core conductor. The armor layer has an annular cross section centered around the central axis of the single core conductor and is formed of a non-conductive material incapable of conducting a current. The armor layer is radially exterior of the insulation member.

In alternate embodiments the method can further include providing a sheathing circumscribing the armor layer. At least one layer of water blocking tape circumscribing the single core conductor and extending the length of the single core conductor can be provided. The at least one layer of water blocking tape can have an annular cross section centered around the central axis of the single core conductor. A supply end and a load end of the power cable can be connected to equipment through a ferrous plate. A supply end of the power cable can be connected to a supply and a load end of the power cable can be connected to the device. The armor layer can be free of a voltage over an axial length of the armor layer.

### BRIEF DESCRIPTION OF THE DRAWINGS

So that the manner in which the above-recited features, aspects and advantages of the embodiments of this disclosure, as well as others that will become apparent, are attained and can be understood in detail, a more particular description of the disclosure briefly summarized above may be had by reference to the embodiments thereof that are illustrated in the drawings that form a part of this specification. It is to be noted, however, that the appended drawings illustrate only preferred embodiments of the disclosure and are, therefore, not to be considered limiting of the disclosure's scope, for the disclosure may admit to other equally effective embodiments.

FIG. 1 is a schematic diagram of a power cable extending from a power source and a device, in accordance with an embodiment of this disclosure.

FIG. 2 is a schematic cross section view of a power cable, in accordance with an embodiment of this disclosure.

### DETAILED DESCRIPTION OF THE DISCLOSURE

Embodiments of the present disclosure will now be described more fully hereinafter with reference to the accompanying drawings which illustrate embodiments of the disclosure. Systems and methods of this disclosure may, however, be embodied in many different forms and should not be construed as limited to the illustrated embodiments set forth herein. Rather, these embodiments are provided so that this disclosure will be thorough and complete, and will fully convey the scope of the disclosure to those skilled in the art. Like numbers refer to like elements throughout, and the prime notation, if used, indicates similar elements in alternative embodiments or positions.

In the following discussion, numerous specific details are set forth to provide a thorough understanding of the present disclosure. However, it will be obvious to those skilled in the art that embodiments of the present disclosure can be practiced without such specific details. Additionally, for the most part, details concerning well drilling, reservoir testing, well completion and the like have been omitted inasmuch as such details are not considered necessary to obtain a complete understanding of the present disclosure, and are considered to be within the skills of persons skilled in the relevant art.

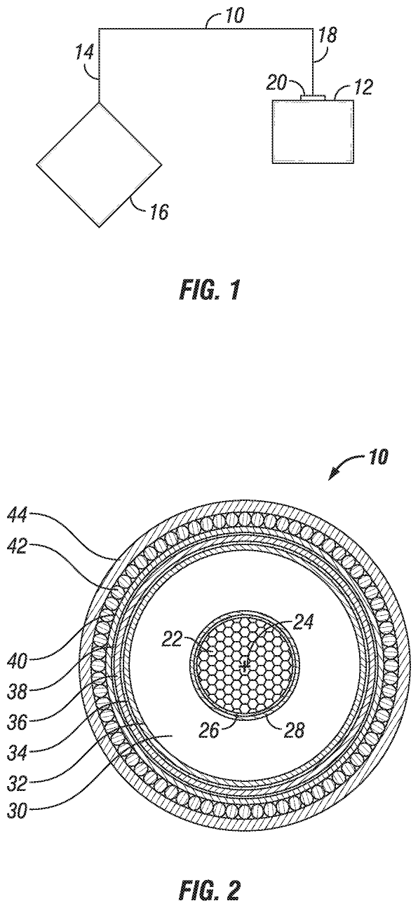

Looking at FIG. 1, cable 10 can be used for providing power to device 12. Device 12 can be, for example equipment or tools used in a hydrocarbon development operation. Cable 10 has supply end 14 operable to be connected to supply 16. Supply 16 is a power supply that is a source of electric power. Cable 10 can have load end 18 that is opposite supply end 14. Load end 18 is operable to be connected to device 12. Cable 10 delivers electrical power from supply 16 to device 12.

Supply end 14 and load end 18 are operable to be connected to equipment, such as device 12 or supply 16 through ferrous plate 20. In some current systems with conductive armor layers, the power cable can be connected to equipment through a non-conductive plate to isolate the armor layer from the equipment and from being grounded through the equipment. Embodiments of this application instead allow for the armor layer to be directly connected to equipment through conductive plates or other types of conductive connectors, without a risk of the armor layer supplying a current to the equipment or grounding through the equipment. In such a system circulating current would be present in the armor layer if armor layer is made of conductive materials.

Looking at FIG. 2, cable 10 is a single core power cable with single core conductor 22. A single core power cable has only one conductor member. Single core conductor 22 is an elongated member with central axis 24. Single core conductor 22 is operable to conduct electricity. In the example of FIG. 2, single core conductor 22 is shown as a stranded core. A stranded core has a number of individual wires that make up a single core conductor 22. In alternate embodiments, single core conductor 22 can be formed of a single solid wire. Single core conductor 22 can be formed of a conductive material for delivering electric power from supply 16 to device 12. In certain embodiments, single core conductor 22 can be formed of copper or aluminum, or other known material used to transmit electric power.

Single core conductor 22 can be surrounded by inner water blocking tape 26, or inner semiconductor 28, or both inner water blocking tape 26 and inner semiconductor 28. Both inner water blocking tape 26 and inner semiconductor 28 can circumscribe single core conductor 22 and extend the length of single core conductor 22. Both inner water blocking tape 26 and inner semiconductor 28 can have an annular cross section centered around central axis 24 of single core conductor 22. Both inner water blocking tape 26 and inner semiconductor 28 can be formed of a semi conductive material.

Insulation member 30 circumscribes single core conductor 22 and extends the length of single core conductor 22. Insulation member 30 can have an annular cross section centered around central axis 24 of single core conductor 22. Insulation member 30 prevents short circuits and current leakage. Commonly used insulating materials include polypropylene, ethylene propylene diene monomer (EPDM), and Nitrile rubbers. Polypropylene is a thermoplastic material, and can be used up to a temperature of around 200F. EPDM is a thermosetting plastic material can be used at operating temperatures of 400F and above.

Supplementary protective layers can be applied over insulation member 30. In the example embodiment of FIG. 2, the supplementary protective layers include outer semiconductor 32, middle water blocking tape 34, screen copper tape 36, outer water blocking tape 38, and bedding 40. Each of outer semiconductor 32, middle water blocking tape 34, screen copper tape 36, outer water blocking tape 38, and bedding 40 can circumscribe single core conductor 22 and extend the length of single core conductor 22. Each of outer semiconductor 32, middle water blocking tape 34, screen copper tape 36, outer water blocking tape 38, and bedding 40 can have an annular cross section centered around central axis 24 of single core conductor 22. Each of outer semiconductor 32, middle water blocking tape 34, screen copper tape 36, and outer water blocking tape 38 can be formed of a semi conductive material.

Armor layer 42 circumscribes single core conductor 22 and can extend the length of single core conductor 22. Armor layer 42 has an annular cross section centered around central axis 24 of single core conductor 22. Armor layer 42 is particularly useful in harsh environments for protecting cable 10. Armor layer 42 can further protect cable 10 from getting pinched, cut, or otherwise damaged. Armor layer 42 is radially exterior of the insulation member 30 so that armor layer 42 can protect both insulation member 30 and single core conductor 22. Sheathing 44 can circumscribe armor layer 42.

Armor layer 42 is formed of a non-conductive material. The material used to form armor layer 42 is incapable of conducting a current so that armor layer 42 is free of a voltage over an axial length of armor layer 42. As is known, both metallic materials and non-metallic materials can be conductive. As an example, conductive materials include metals, electrolytes, superconductors, semiconductors, plasmas, graphite and conductive polymers. Therefore, armor layer 42 is not formed of such conductive materials.

In an example of operation cable 10 can deliver electrical power from supply 16 to device 12. While delivering electrical power through single core conductor 22, no current will travel through armor layer 42. As an example, armor layer 42 will be free of a circulating current, an eddy current, or a system fault. Because armor layer 42 is incapable of conducting a current, the armor layer will not produce power losses, such as by heating, and will not decrease the capacity of carrying current of the power cable. The armor layer will not generate a magnetic field that would alter the overall magnetic field of the power cable. Therefore, embodiments disclosed in this disclosure provide an armor layer that provides physical protection to the single core power cable and that is non-conductive.

Embodiments of the disclosure described herein, therefore, are well adapted to carry out the objects and attain the ends and advantages mentioned, as well as others inherent therein. While a presently preferred embodiment of the disclosure has been given for purposes of disclosure, numerous changes exist in the details of procedures for accomplishing the desired results. These and other similar modifications will readily suggest themselves to those skilled in the art, and are intended to be encompassed within the spirit of the present disclosure and the scope of the appended claims.

That claimed is:

1. A cable for providing power to a device in a hydrocarbon development operation, the cable having:
a single core power cable, the single core power cable having a single core conductor that is an elongated member with a central axis and operable to conduct electricity;
an insulation member circumscribing the single core conductor and extending a length of the single core conductor, the insulation member having an annular cross section centered around the central axis of the single core conductor;
an armor layer circumscribing the single core conductor and extending the length of the single core conductor, the armor layer having an annular cross section centered around the central axis of the single core conductor and being formed of a non-conductive material so that the armor layer is incapable of conducting a current; where
the armor layer is radially exterior of the insulation member; and
the cable has a supply end and a load end, where the armor layer at the supply end and the load end is operable to be connected to the device through a ferrous plate.

2. The cable of claim 1, further including a sheathing circumscribing the armor layer.

3. The cable of claim 1, further including at least one layer of water blocking tape circumscribing the single core conductor and extending the length of the single core conductor, the at least one layer of water blocking tape having an annular cross section centered around the central axis of the single core conductor.

4. (canceled)

5. The cable of claim 1, further including a supply end and a load end, where the supply end is operable to be connected to a supply and the load end is operable to be connected to the device.

6. The cable of claim 1, where the armor layer is free of a voltage over an axial length of the armor layer.

7. A system for providing power to a device in a hydrocarbon development operation, the system having:
a power supply;
a single core power cable extending from the power supply to the device, the single core power cable having:
a single core conductor, the single core conductor being an elongated member with a central axis and operable to conduct electricity;
an insulation member circumscribing the single core conductor and extending a length of the single core conductor, the insulation member having an annular cross section centered around the central axis of the single core conductor;
an armor layer circumscribing the single core conductor and extending the length of the single core conductor, the armor layer having an annular cross section centered around the central axis of the single core conductor and being formed of a non-conductive material so that the armor layer is incapable of conducting a current; where
the armor layer is radially exterior of the insulation member;
the cable has a supply end and a load end, where the armor layer at the supply end and the load end is connected to the device through a ferrous plate; and
the armor layer is free of a voltage over an axial length of the armor layer.

8. The system of claim 7, further including a sheathing circumscribing the armor layer.

9. The system of claim 7, further including at least one layer of water blocking tape circumscribing the single core conductor and extending the length of the single core conductor, the at least one layer of water blocking tape having an annular cross section centered around the central axis of the single core conductor.

10. A method for providing power to a device in a hydrocarbon development operation, the method including:
extending a single core power cable from a power supply to the device, the single core power cable having:
a single core conductor, the single core conductor being an elongated member with a central axis and operable to conduct electricity;
an insulation member circumscribing the single core conductor and extending a length of the single core conductor, the insulation member having an annular cross section centered around the central axis of the single core conductor;
an armor layer circumscribing the single core conductor and extending the length of the single core conductor, the armor layer having an annular cross section centered around the central axis of the single core conductor and being formed of a non-conductive material so that the armor layer is incapable of conducting a current; where
the armor layer is radially exterior of the insulation member; and
the cable has a supply end and a load end, where the armor layer at the supply end and the load end is connected to the device through a ferrous plate.

11. The method of claim 10, further including providing a sheathing circumscribing the armor layer.

12. The method of claim 10, further including providing at least one layer of water blocking tape circumscribing the single core conductor and extending the length of the single core conductor, the at least one layer of water blocking tape having an annular cross section centered around the central axis of the single core conductor.

13. (canceled)

14. The method of claim 10, further including connecting a supply end of the single core power cable to a supply and connecting a load end of the single core power cable to the device.

15. The method of claim 10, where the armor layer is free of a voltage over an axial length of the armor layer.
